(19) United States
(12) Patent Application Publication
(10) Pub. No.: US 2026/0352535 A1
(43) Pub. Date: Nov. 5, 2026

(54) SOUNDING REFERENCE SIGNAL ENHANCEMENT FOR NETWORK ENTITY BASED UPLINK BEAM PREDICTION

(71) Applicant: QUALCOMM Incorporated, San Diego, CA (US)

(72) Inventors: Qiaoyu LI, Beijing (CN); Tao LUO, San Diego, CA (US); Mahmoud TAHERZADEH BOROUJENI, San Diego, CA (US)

(21) Appl. No.: 19/478,204

(22) PCT Filed: Jun. 22, 2023
(86) PCT No.: PCT/CN2023/101992

§ 371 Date: Oct. 23, 2025

(51) Int. Cl. H04L 27/26; H04L 5/00

(52) U.S. Cl. CPC H04L 27/261; H04L 5/0044

(57) ABSTRACT

An apparatus, method and computer-readable media are disclosed for performing wireless communications. For example, a process can include receiving an indication of a sounding reference signal (SRS) resource set; transmitting, during a first SRS transmission occasion, a first set of SRS signals based on a first set of SRS resources from the SRS resource set; transmitting, during a second SRS transmission occasion, a second set of SRS signals based on a second set of SRS resources from the SRS resource set, wherein the second set of SRS signals are transmitted after the first set of SRS signals, wherein the first set of SRS signals and second set of SRS signals are time division multiplexed (TDM) SRS signals; receiving, after the second set of SRS signals are transmitted, a first SRS resource indicator (SRI) identifying a first SRS signal; and transmitting an uplink message based on the first SRS signal.

### FIELD

The present disclosure generally relates to wireless communications. For example, aspects of the present disclosure relate to systems and techniques for non-codebook sound reference signal (SRS) enhancement for network entity based uplink (UL) beam prediction.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments.

In some cases, user equipment (UE) may transmit a reference signal (e.g., a sounding reference signal (SRS)) for use by a by a network entity (e.g., a base station, such as a gNB) for channel quality estimation for uplink (UL) scheduling. For example, the network entity can use an SRS to determine channels that may be used by a UE for UL transmissions.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for performing wireless communications. In current wireless communications systems (e.g., a 5G/NR wireless communications system), a UE may be configured with one or two non-codebook sounding reference signal (SRS) resource sets. For example, when a UE is configured with two SRS resource sets, the UE may apply at most two SRS resource sets (e.g., as indicated in two SRS resource indicators (SRIs)) to different physical uplink shared channel (PUSCH) repetitions. Each SRI is associated with a most-recent transmission of the SRS resources prior to a physical downlink control channel (PDCCH) carrying the SRI. In such situations, the UE will not expect to be configured with a different number of SRS resources in the two SRS resource sets. However, as configured, the UE cannot transmit non-codebook SRSs with a relatively long periodicity where the UE can alter its precoding of the SRSs across different SRS transmission occasions (e.g., referring to a slot and symbol identifier (ID) where an SRS was transmitted on an SRS resource by a UE.

Systems and techniques are described herein provide enhancements to reference signals, including SRS. For instance, according to some aspects, an SRI (e.g., included in downlink control information (DCI)) can refer to multiple previous SRS transmission occasions. In one example, a UE may be configured with one SRS resource set. The UE may then transmit a first set of beams during a first SRS transmission occasion using time division multiplexed (TDM) SRS resources (e.g., across different slots allocated for SRS in a time domain) of the SRS resource set. The network entity may analyze the first set of beams to predict which beams may provide better quality UL transmissions. The UE may then transmit a second set of beams during a second SRS transmission occasion and the network entity may analyze the second set of beams. The network entity may then transmit an SRI identifying SRS transmissions, such as by SRS transmission occasions, from multiple previous SRS transmission occasions, such as the first and second SRS transmission occasions.

In one illustrative example, an apparatus for wireless communications by a user equipment (UE) is provided. The apparatus includes at least one memory and at least one processor coupled to the at least one memory. The at least one processor is configured to: receive an indication of at least one sounding reference signal (SRS) resource set from a network entity; transmit, during a first SRS transmission occasion, a first set of SRS signals based on a first set of SRS resources from the at least one SRS resource set; transmit, during a second SRS transmission occasion, a second set of SRS signals based on a second set of SRS resources from the at least one SRS resource set, wherein the second set of SRS signals are transmitted after the first set of SRS signals, wherein the first set of SRS signals and second set of SRS signals are time division multiplexed (TDM) SRS signals; receive, from the network entity after the second set of SRS signals are transmitted, a first SRS resource indicator (SRI), the SRI identifying a first SRS signal from the first set of SRS signals; and transmit an uplink message to the network entity based on the first SRS signal.

As another example, a method of wireless communications performed by a user equipment (UE) is provided. The method includes: receiving an indication of at least one sounding reference signal (SRS) resource set from a network entity; transmitting, during a first SRS transmission occasion, a first set of SRS signals based on a first set of SRS resources from the at least one SRS resource set; transmitting, during a second SRS transmission occasion, a second set of SRS signals based on a second set of SRS resources from the at least one SRS resource set, wherein the second set of SRS signals are transmitted after the first set of SRS signals, wherein the first set of SRS signals and second set of SRS signals are time division multiplexed (TDM) SRS signals; receiving, from the network entity after the second set of SRS signals are transmitted, a first SRS resource indicator (SRI), the SRI identifying a first SRS signal from the first set of SRS signals; and transmitting an uplink message to the network entity based on the first SRS signal.

In another example, a non-transitory computer-readable medium is provided. The non-transitory medium has stored thereon instructions that, when executed by at least one processor, cause the at least one processor to: receive an indication of at least one sounding reference signal (SRS) resource set from a network entity; transmit, during a first SRS transmission occasion, a first set of SRS signals based on a first set of SRS resources from the at least one SRS resource set; transmit, during a second SRS transmission occasion, a second set of SRS signals based on a second set of SRS resources from the at least one SRS resource set, wherein the second set of SRS signals are transmitted after the first set of SRS signals, wherein the first set of SRS signals and second set of SRS signals are time division multiplexed (TDM) SRS signals; receive, from the network entity after the second set of SRS signals are transmitted, a first SRS resource indicator (SRI), the SRI identifying a first SRS signal from the first set of SRS signals; and transmit an uplink message to the network entity based on the first SRS signal.

As another example, an apparatus for wireless communications is provided. The apparatus includes means for: receiving an indication of at least one sounding reference signal (SRS) resource set from a network entity; means for transmitting, during a first SRS transmission occasion, a first set of SRS signals based on a first set of SRS resources from the at least one SRS resource set; means for transmitting, during a second SRS transmission occasion, a second set of SRS signals based on a second set of SRS resources from the at least one SRS resource set, wherein the second set of SRS signals are transmitted after the first set of SRS signals, wherein the first set of SRS signals and second set of SRS signals are time division multiplexed (TDM) SRS signals; means for receiving, from the network entity after the second set of SRS signals are transmitted, a first SRS resource indicator (SRI), the SRI identifying a first SRS signal from the first set of SRS signals; and means for transmitting an uplink message to the network entity based on the first SRS signal.

In another example, an apparatus for wireless communications by a network entity is provided. The apparatus includes: at least one memory; and at least one processor coupled to the at least one memory and configured to: transmit an indication of at least one sounding reference signal (SRS) resource set to a user equipment (UE); receive, during a first SRS transmission occasion, a first set of SRS signals based on a first set of SRS resources from the at least one SRS resource set; receive, during a second SRS transmission occasion, a second set of SRS signals based on a second set of SRS resources from the at least one SRS resource set, wherein the second set of SRS signals are transmitted after the first set of SRS signals, wherein the first set of SRS signals and second set of SRS signals are time division multiplexed (TDM) SRS signals; determine, a first SRS resource indicator (SRI), the SRI identifying a first SRS signal from the first set of SRS signals; transmit, to the UE after the second set of SRS signals are received, the first SRS SRI; and receive an uplink message from the UE based on the first SRS signal.

As another example, a method of communications by a network entity is provided. The method includes: transmitting an indication of at least one sounding reference signal (SRS) resource set to a user equipment (UE); receiving, during a first SRS transmission occasion, a first set of SRS signals based on a first set of SRS resources from the at least one SRS resource set; receiving, during a second SRS transmission occasion, a second set of SRS signals based on a second set of SRS resources from the at least one SRS resource set, wherein the second set of SRS signals are transmitted after the first set of SRS signals, wherein the first set of SRS signals and second set of SRS signals are time division multiplexed (TDM) SRS signals; determining, a first SRS resource indicator (SRI), the SRI identifying a first SRS signal from the first set of SRS signals; transmitting, to the UE after the second set of SRS signals are received, the first SRS SRI; and receiving an uplink message from the UE based on the first SRS signal.

In another example, a non-transitory computer-readable medium is provided. The non-transitory medium has stored thereon instructions that, when executed by at least one processor, cause the at least one processor to: transmit an indication of at least one sounding reference signal (SRS) resource set to a user equipment (UE); receive, during a first SRS transmission occasion, a first set of SRS signals based on a first set of SRS resources from the at least one SRS resource set; receive, during a second SRS transmission occasion, a second set of SRS signals based on a second set of SRS resources from the at least one SRS resource set, wherein the second set of SRS signals are transmitted after the first set of SRS signals, wherein the first set of SRS signals and second set of SRS signals are time division multiplexed (TDM) SRS signals; determine, a first SRS resource indicator (SRI), the SRI identifying a first SRS signal from the first set of SRS signals; transmit, to the UE after the second set of SRS signals are received, the first SRS SRI; and receive an uplink message from the UE based on the first SRS signal.

As another example, an apparatus for wireless communications is provided. The apparatus includes means for transmitting an indication of at least one sounding reference signal (SRS) resource set to a user equipment (UE); receiving, during a first SRS transmission occasion, a first set of SRS signals based on a first set of SRS resources from the at least one SRS resource set; means for receiving, during a second SRS transmission occasion, a second set of SRS signals based on a second set of SRS resources from the at least one SRS resource set, wherein the second set of SRS signals are transmitted after the first set of SRS signals, wherein the first set of SRS signals and second set of SRS signals are time division multiplexed (TDM) SRS signals; means for determining, a first SRS resource indicator (SRI), the SRI identifying a first SRS signal from the first set of SRS signals; means for transmitting, to the UE after the second set of SRS signals are received, the first SRS SRI; and means for receiving an uplink message from the UE based on the first SRS signal.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 is a diagram illustrating an example of an uplink frame structure, according to aspects of the disclosure;

FIG. 6 illustrates signals for network node based beam selection for an UL transmission 600, in accordance with aspects of the present disclosure;

FIG. 7 illustrates signals for an enhanced non-codebook sounding reference signal (SRS) network node based beam selection for an UL transmission, in accordance with aspects of the present disclosure;

FIGS. 8A and 8B are block diagrams illustrating DCI formats for indicating an SRS transmission occasion where a single SRS resource set is configured, in accordance with aspects of the present disclosure;

FIGS. 9A and 9B are block diagrams illustrating DCI formats for indicating an SRS transmission occasion where a multiple SRS resource sets are configured;

FIG. 10 is a flow diagram illustrating example processes for wireless communication, in accordance with aspects of the present disclosure; and

FIG. 11 is a diagram illustrating an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a 3^{rd} Generation Partnership Project (3GPP) gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

Systems and techniques are described for non-codebook reference signal (e.g., sounding reference signal (SRS)) enhancement for network entity (e.g., base station, such as a gNB)-based uplink beam prediction. An SRS will be used here as an example of an uplink reference signal. However, the systems and techniques described herein can be used to enhance other types of uplink reference signals.

Currently, a UE may be configured with one or two non-codebook SRS resource sets. When two SRS resource sets are configured, a UE may apply at most two SRS resource sets (e.g., as indicated in two SRS resource indicators (SRIs)) to different physical uplink shared channel (PUSCH) repetitions. Each SRI is associated with a most-recent transmission of SRS resources prior to a physical downlink control channel (PDCCH) carrying the SRI. Thus, a UE does not expect to be configured with a different number of SRS resources in the two SRS resource sets. However, as configured, a UE cannot transmit non-codebook SRSs with a relatively long periodicity where the UE can alter its precoding of the SRSs across different SRS transmission occasions. An SRS transmission occasion may refer to a slot and symbol ID (e.g., in a time domain) where an SRS was transmitted on an SRS resource by a UE.

As noted above, the systems and techniques described herein provide SRS enhancement. In some cases, an SRI (e.g., an SRI indicated for a certain PUSCH) can refer to multiple previous SRS transmission occasions. In some cases, these referred to previous SRS transmission occasions may have been predicted by an artificial intelligence (AI) and/or machine learning (ML) model (e.g., a neural network model) of a network entity or other wireless node. As an example, a UE may be configured with one SRS resource set. The UE may then transmit a first set of beams during a first SRS transmission occasion using time division multiplexed (TDM) SRS resources (e.g., across different slots allocated for SRS in a time domain) of the SRS resource set. The network entity may analyze the first set of beams to predict which beams may provide better quality UL transmissions using an AI and/or ML model. The UE may then transmit a second set of beams during a second SRS transmission occasion and the network entity may analyze the second set of beams as well.

The network entity may then transmit an SRI identifying SRS transmissions, such as SRS transmission occasions, from multiple previous SRS transmission occasions, such as the first and second SRS transmission occasions. In some cases, the SRI may be included in a downlink control information (DCI) message. Beams corresponding to those identified previous SRS transmissions may then be used to transmit a UL message to the network entity. In some cases, the UE may be configured with multiple SRS resource sets. In such cases, the UE may transmit SRSs in multiple SRS transmission occasions, as discussed above, and the network entity may transmit the SRI identifying an SRS transmission to use for UL. Where there are multiple SRS resource sets, the SRI may use an SRS resource set identifier to identify a selected SRS resource set.

In some aspects, a network entity may have a UE transmit a message using a higher rank, such as a rank 2 PUSCH, such that the precoders may be associated with multiple previously transmitted SRSs. In such a case, a single DCI may indicate multiple SRS transmission occasions or multiple SRS resource sets.

In some cases, it may be useful to allow the network entity to have some understanding of beam characteristics of the UE to help better predict UL beams. In some cases, the UE may explicitly report its UL beam characteristics to a network entity. The UE may also indicate which beam was used for transmitting in a corresponding SRS resource. In other cases, an AI/ML model may be used to allow the network entity to have some understanding of the beam characteristics of a UE. For example, an AI/ML model for UL beam prediction may be trained by a UE vendor and provided to a network entity to use for predicting UL beams. The UE may provide a beam identifier corresponding to a beam used for an SRS resource and the AI/ML model may use this beam identifier to predict precoders for use with UL transmissions.

In some cases, it may be useful to allow the UL grant DCI to schedule multiple UL repetitions (e.g., PUSCH repetitions) or multiple SDM'ed/FDM'ed PUSCHs. In some cases, SRIs associated with different repetitions of the multiple UL repetitions may be included to allow different beams to be used for the different repetitions.

In some aspects, the techniques described above may be applied to non-codebook-based SRS as well as codebook-based SRS. In some cases, non-codebook-based SRS operations may use an SRS and PUSCH transmissions, while codebook-based SRS operations may use a SRS and transmit precoder matrix indicator (TPMI) transmissions.

In some cases, allowing the identification of SRS transmissions from multiple previous SRS transmission occasions or SRS resource sets may be extended to support uplink transmission configuration indicator (UL-TCI) state switching. In some cases, a UL-TCI state may be associated with an SRS resource. A medium access control (MAC) control element (MAC-CE) activating the UL-TCI-state may indicate a previous SRS occasion associated with the SRS resource. The candidates of the SRS occasion can be based on multiple previous SRS transmission occasions.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

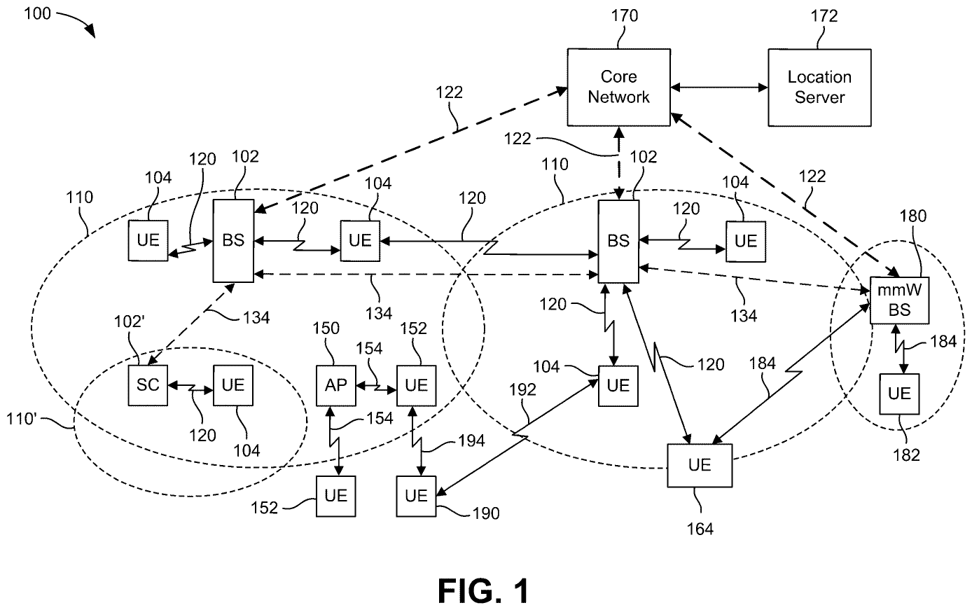

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or fewer carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

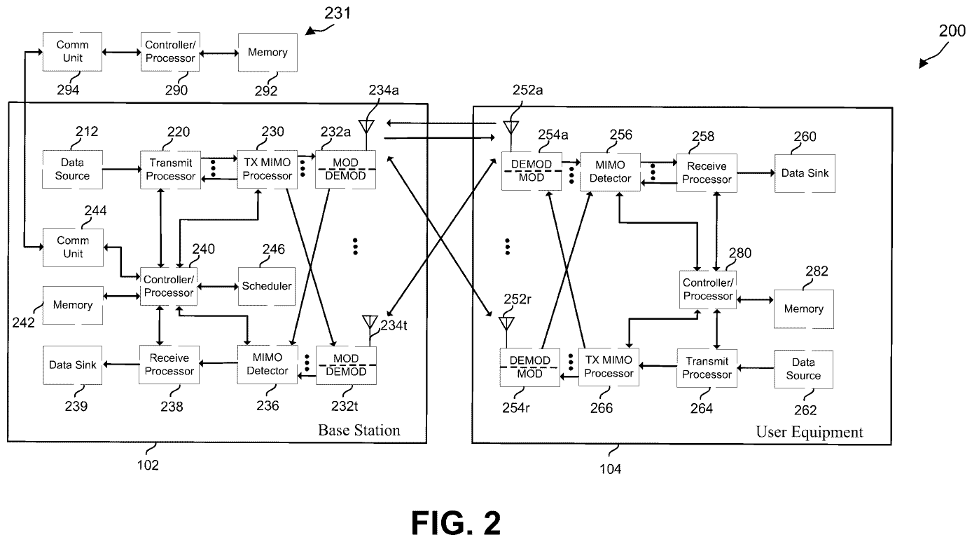

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, channel state information, channel state feedback, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, channel state information, channel state feedback, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit uplink control information (UCI) beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

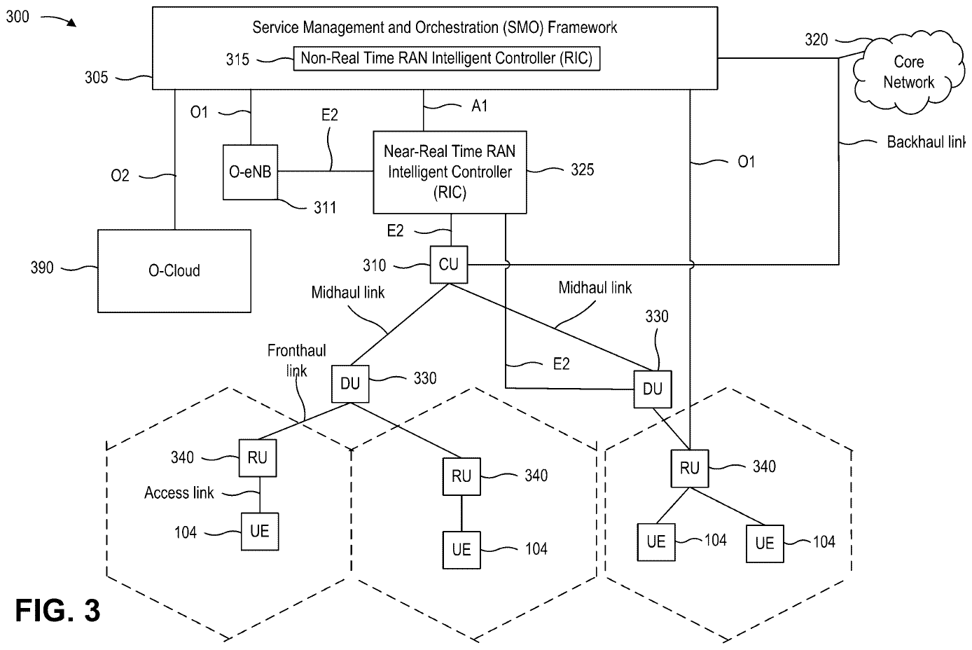

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUS 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

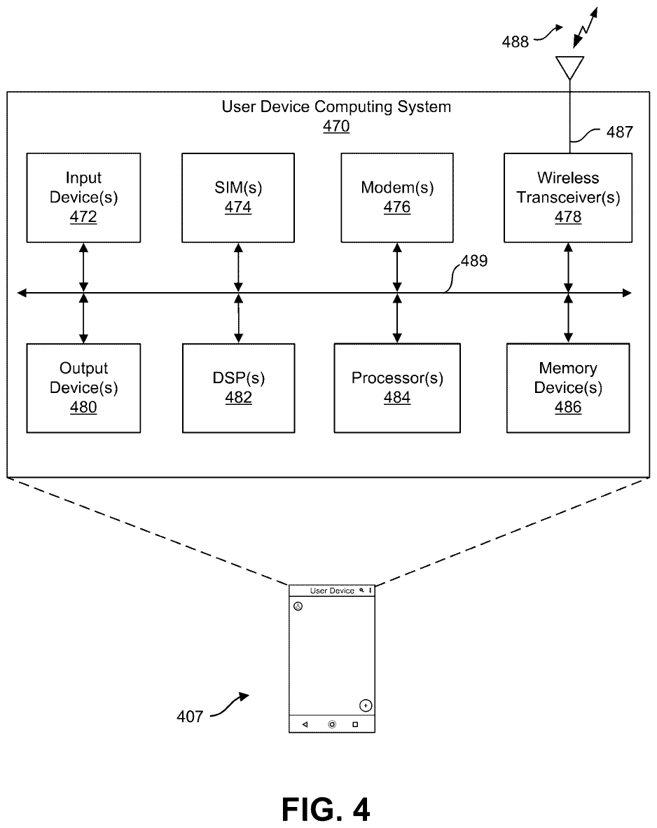

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

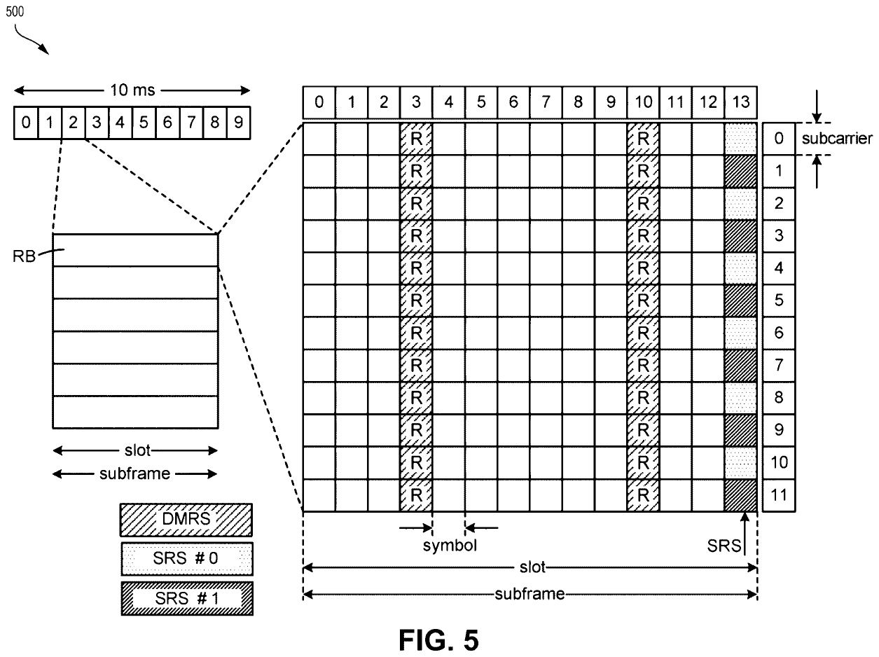

FIG. 5 is a diagram 500 illustrating an example of an uplink frame structure, according to aspects of the disclosure. LTE, and in some cases NR, utilizes OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (resource block) may be 12 subcarriers (or 180 kHz). Consequently, the nominal FFT size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing, symbol length, etc.). In contrast, NR may support multiple numerologies, for example, subcarrier spacing of 15 kHz, 30 kHz, 60 kHz, 120 kHz and 240 kHz or greater may be available. In the example of FIG. 4, a numerology of 15 kHz is used. Thus, in the time domain, a frame (e.g., 10 ms) is divided into 10 equally sized subframes of 1 ms each, and each subframe includes one time slot. In FIG. 5, time is represented horizontally (e.g., on the X axis) with time increasing from left to right, while frequency is represented vertically (e.g., on the Y axis) with frequency increasing (or decreasing) from bottom to top.

A resource grid may be used to represent time slots, each time slot including one or more time concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 5, for a normal cyclic prefix, an RB may contain 12 consecutive subcarriers in the frequency domain and 7 consecutive symbols (for DL, OFDM symbols; for UL, SC-FDMA symbols) in the time domain, for a total of 84 REs. For an extended cyclic prefix, an RB may contain 12 consecutive subcarriers in the frequency domain and 6 consecutive symbols in the time domain, for a total of 72 REs. The number of bits carried by each RE depends on the modulation scheme.

As illustrated in FIG. 5, some of the REs carry demodulation reference signals (DMRS) for channel estimation at the base station. The UE may additionally transmit sounding reference signals (SRS) in, for example, the last symbol of a subframe. The SRS may have a comb structure, and a UE may transmit SRS on one of the combs. The comb structure (also referred to as the “comb size”) indicates the number of subcarriers in each symbol period carrying a reference signal (here, SRS). For example, a comb size of comb-4 means that every fourth subcarrier of a given symbol carries the reference signal, whereas a comb size of comb-2 means that every second subcarrier of a given symbol carries the reference signal. In the example of FIG. 5, the illustrated SRS are both comb-2. The SRS may be used by a base station to obtain the channel state information (CSI) for each UE. CSI describes how an RF signal propagates from the UE to the base station and represents the combined effect of scattering, fading, and power decay with distance. The system uses the SRS for resource scheduling, link adaptation, massive MIMO, beam management, etc.

A collection of resource elements that are used for transmission of SRS is referred to as an “SRS resource.” The collection of resource elements can span multiple PRBs in the frequency domain and N (e.g., 1 or more) consecutive symbol(s) within a slot in the time domain. In a given OFDM symbol, an SRS resource occupies consecutive PRBs. An “SRS resource set” is a set of SRS resources used for the transmission of SRS signals.

Several enhancements over the previous definition of SRS have been proposed for SRS for positioning, such as a new staggered pattern within an SRS resource (except for single-symbol/comb-2), a new comb type for SRS, new sequences for SRS, a higher number of SRS resource sets per component carrier, and a higher number of SRS resources per component carrier. In addition, the parameters “SpatialRelationInfo” and “PathLossReference” are to be configured based on a downlink reference signal or SSB from a neighboring TRP. Further still, one SRS resource may be transmitted outside the active bandwidth part (BWP), and one SRS resource may span across multiple component carriers. Also, SRS may be configured in RRC connected state and only transmitted within an active BWP. Further, there may be no frequency hopping, no repetition factor, a single antenna port, and new lengths for SRS (e.g., 8 and 12 symbols). There may also be open-loop power control and not closed-loop power control, and comb-8 (i.e., an SRS transmitted every eighth subcarrier in the same symbol) may be used. Lastly, the UE may transmit through the same transmit beam from multiple SRS resources for UL-AoA. All of these are features that are additional to the current SRS framework, which is configured through RRC higher layer signaling (and potentially triggered or activated through MAC control element (CE) or downlink control information (DCI)).

Conventionally, an SRS resource set can be tagged with one of the following use cases: codebook (CB) based, non-codebook (NCB) based, antenna switching (AntSw), and uplink beam management (ULBM). The CB and NCB use cases are for uplink traffic, the AntSw use case is to facilitate downlink traffic, and the ULBM use case allows the UE to find the correct uplink beam to transmit data. In other words, the existing use cases are for communication purposes, i.e., to enhance communication between the UE and the serving base station (or serving cell). For example, the UE may transmit the SRS and the base station may use the received SRS to determine the quality of the communication channel between the base station and the UE (e.g., for scheduling and link adaptation).

Each SRS resource set can have multiple SRS resources. A codebook-based set can have up to two (2) SRS resources, a non-codebook-based set can have up to four (4) SRS resources, an uplink beam management set can have up to sixteen (16) SRS resources, and an antenna switching set can have up to four (4) SRS resources. An SRS resource can contain one (1), two (2), or four (4) antenna ports with a comb-2 or comb-4 pattern and span specific symbols and physical resource blocks (PRBs) in the frequency domain. All antenna ports (or simply “ports”) on an SRS resource have an assigned comb offset where no frequency staggering of the resource elements (REs) inside the SRS resource is allowed. The comb offset is the difference between the first subcarrier of a comb pattern and a reference subcarrier (e.g., the first subcarrier of a resource block). For example, in FIG. 5, “SRS #0” has a comb offset of 0 (there are no subcarriers between the first subcarrier of “SRS #0” and subcarrier 0) and “SRS #1” has a comb offset of 1 (there is one subcarrier between the first subcarrier of “SRS #1” and subcarrier 0).

The conventional SRS configuration also includes time-domain constraints. For example, a UE may be configured by a higher layer parameter resourceMapping in SRS-Resource with an SRS resource occupying NS∈{1, 2, 4} adjacent symbols within the last six (6) symbols of the slot, in which all antenna ports of the SRS resources are mapped to each symbol of the resource. When a physical uplink shared channel (PUSCH) and an SRS are transmitted in the same slot, the UE can only be configured to transmit the SRS after the PUSCH and the corresponding DMRS are transmitted. In other words, the SRS is transmitted last within a slot, as illustrated in FIG. 5.

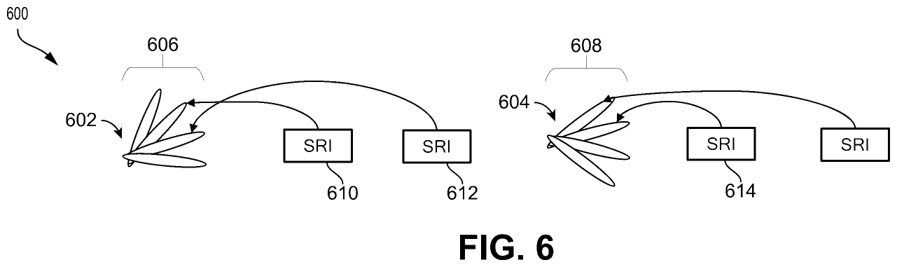

FIG. 6 illustrates signals for network node-based beam selection for an UL transmission 600, in accordance with aspects of the present disclosure. In some wireless networks, a limited number of SRS resource sets may be configured at a time. For example, up to two (e.g., zero, one, or two) SRS resource sets may be configured for non-codebook usage. In some cases, where SRS resources are configured for non-codebook usage, a UE may transmit sets of SRS beams on a group of SRS resources 602, 604 (e.g., SRSs) based on a set of preconfigured precoders using TDM'ed SRS resources (e.g., where the UE alters the precoding of the SRS beams across different time domain occasions). A precoder for the UL beams may be UE implementation-based. In some cases, a first set of SRS beams may be transmitted using a first group of SRS resources 602 and a second set of SRS beams may be transmitted using a second group of SRS resources 604. In some cases, SRS resources of the first group of SRS resources and second group of SRS resources may be based on one or multiple SRS resource sets. The first group of SRS resource 602 may be transmitted during a first SRS transmission occasion 606, which is earlier in time than a second SRS transmission occasion 608 during which the second group of SRS resources 604 are transmitted.

In such cases, a network node, such as a gNB (not shown), may receive and measure the received SRS beams. The network node may then select an SRS resource (e.g., SRS beam) for an UL transmission by the UE based on the SRS measurements. The network node may then transmit an indication of the selected SRS resource to the UE using an SRS resource indicator (SRI) message. For example, the network node may transmit first SRI 610 indicating a first SRS resource to use for a first UL transmission and a second SRI 612 indicating a second SRS resource to use for a second SRS transmission. In some cases, where two SRS resources sets are configured for non-codebook usage, the UE is not expected to be configured with a different number of SRS resources in the two SRS resource sets. The SRS message may be included in a downlink (DL) control information (DCI) message.

In some cases, the SRS resources indicated in a DCI refer to the most recent previous transmission of SRS resources as indicated by the network node and the UE uses a corresponding precoder(s) previously used in the most recent previous SRS transmission for precoding an UL transmission as indicated in the DCI. That is, a third SRI 614 may refer to an SRS resource of the second group of SRS resources 604, but the third SRI cannot refer to an SRS resource of the first group of SRS resources 602.

In some cases, there are existing mechanisms by which a network node may control UL precoding behaviors. For example, a network node may configure certain UL transmissions associated with a certain SRS resource where the same spatial domain transmission filter used for transmission and/or reception of the configured reference signal is used for transmitting the SRS resource. As another example, the network node may configure a non-codebook SRS resource set where the UE can calculate the precoder (e.g., determine the precoder) used to transmit the SRSs in the SRS resource set based on a measurement of the configured resources.

However, this level of control may be insufficient when used with network node (e.g., gNB) based UL beam prediction. For example, for UL beam prediction, the network node may configure a UE to transmit non-codebook SRSs with a relatively long periodicity (e.g., across multiple UL transmission occasions, such as 80 ms). During this relatively long periodicity, the UE may change the precoding used for the SRSs across different transmission occasions (e.g., a first set of precoders may be used for a first set of SRS transmissions during a first transmission occasion, and a second set of precoders may be used for a second set of SRS transmissions during a second), later, transmission occasion. In some cases, it may be useful for the network node to select a precoder (e.g., an SRS transmission from a set of SRS transmissions) from either the first set of SRS transmissions or the second set of SRS transmissions. This selection may be performed based on AI/ML techniques based on measurements of the SRS transmissions in the first set of SRS transmissions and the second set of transmissions. However, as a UE uses the most recent previous SRS transmission for precoding an UL transmission, the UE cannot use precoders across the first set of SRS transmission and the second set of SRS transmissions. In some cases, techniques to allow a UE to use precoders other than those precoders used in a most recent previous SRS transmission may be useful. Additionally, the network node has little information about non-codebook SRS beam information (e.g., beam shape, beam direction, beamforming gain, panel directions, etc.) for a given UE, which can make network side UE beam prediction difficult. In some cases, techniques for providing a network node with non-codebook SRS beam information about a UE may be useful

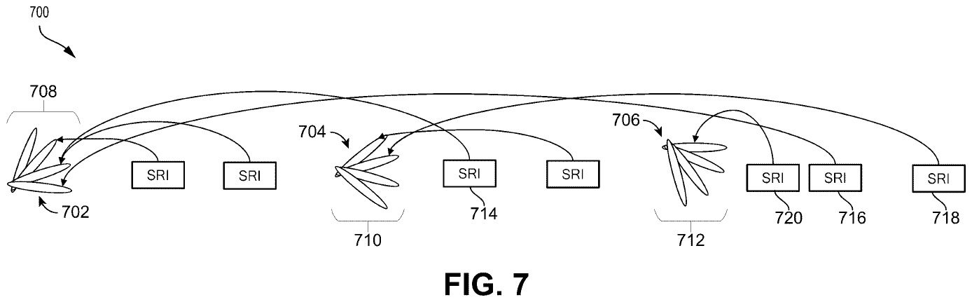

FIG. 7 illustrates signals for an enhanced non-codebook SRS network node-based beam selection for an UL transmission 700, in accordance with aspects of the present disclosure. As shown in FIG. 7, a UE may be configured with one or more non-codebook SRS resource sets. In some cases, where multiple SRS resource sets are used, the different SRS resource sets may be associated with different resources for transmitting SRS, such as different slot-offsets, periodicities, etc. In some cases, the UE may transmit SRS beams on groups of SRS resources 702, 704, 706 during SRS transmission occasions 708, 710, 712 using TDM'ed SRS resources based on the configured SRS resource set(s).

In some cases, non-codebook SRS may be enhanced so that an SRI configuring a UE to transmit a UL transmission, such as a certain PUSCH transmission, can be associated with multiple previous transmission occasions. For example, in FIG. 7, a first set of SRS beams using a first group of SRS resources 702 may be transmitted during a first SRS transmission occasion 708, a second set of SRS beams using a second group of SRS resources 704 may be transmitted during a second SRS transmission occasion 710, and a third set of SRS beams using a second group of SRS resources 706 may be transmitted during a third SRS transmission occasion 712. In FIG. 7, transmissions on the first group of SRS resources 702 may be transmitted before transmissions on the second group of SRS resources 704, which may in turn be transmitted before transmissions on the third group of SRS resources 706.

The network node may receive and measure the SRS beams to select SRS resources to use for an UL transmission, such as a specific PUSCH transmission. In some cases, the network node may use AI/ML techniques to predict SRS beams for use based, for example, on historical SRS measurements. In some cases, the SRI may indicate an SRS resource used during an SRS transmission occasion before the most recent SRS transmission occasion. For example, a first SRI 714, sent after the second SRS transmission occasion 710, may refer to an SRS resource of the first group of SRS resources 702. Similarly, a second SRI 716, sent after the third SRS transmission occasion 712 may refer to an SRS resource of the first group of SRS resources 702, and a third SRI 718, also sent after the third SRS transmission occasion 712 may refer to an SRS resource of the second group of SRS resources 704. In some cases, the SRI may also indicate an SRS resource used during the most recent SRS transmission occasion, such as a fourth SRI 720.

To allow the network node to indicate an SRS resource that was not necessarily used during the most recent SRS transmission occasion, signaling indicating a particular SRS transmission occasion an SRS resource being selected is associated with may be used. In some cases, to identify a specific SRS resource from across multiple SRS transmission occasions with a single SRS resource set is configured, the SRI may identify a particular SRS transmission occasion, such as the second SRS transmission occasion 710, in addition to identifying the SRS resource within the particular SRS transmission occasion. In examples where multiple SRS resources sets are configured with different slot offsets and/or periodicities, the SRI may include an SRS resource set identifier (ID) of the SRS resource.

Where a single SRS resource set is configured, a precoder for a UE to use for transmitting, for example, a PUSCH message, may be indicated to the UE by a network node in a scheduling DCI message. In some cases, the DCI message may include an indication of a number N of most recent transmission occasions of the single SRS resource set that may be referred to. For example, for an SRI sent after the third SRS transmission occasion 712, if Nis set to one (assuming zero indexing), then the SRI may refer to SRS resources used during the third SRS transmission occasion 712 and SRS resources used during the second SRS transmission occasion 710, but not the SRS resources used during the first SRS transmission occasion 708. Similarly, if N is set to two, then the SRI may refer to SRS resources used during the third SRS transmission occasion 712, second SRS transmission occasion 711, or first SRS transmission occasion 708. In some cases, the value of N may be determined based on a predefined (e.g., predetermined) value of N, for example in a standard, based on a configuration from a network node (e.g., through RRC configuration of the SRS resource set, through a separate MAC-CE, etc.), based on a UE recommendation (e.g., UE may report, for example via a capability report, a maximum and/or minimum value of N as a UE capability and the network may configure (e.g., indicate) a value of N based on the report), based on a class of UE, and the like.

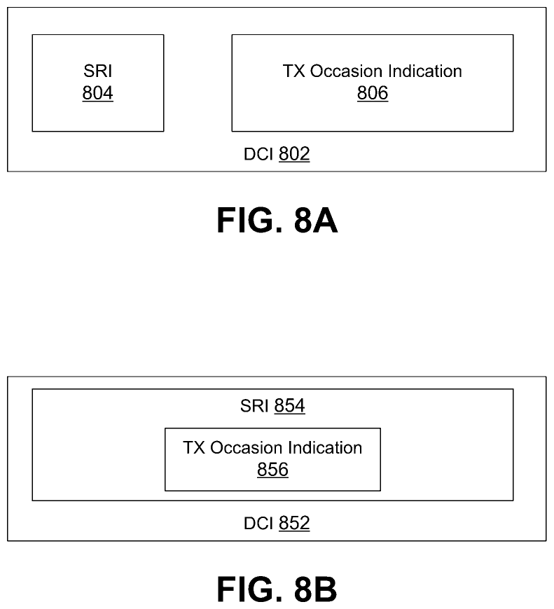

FIGS. 8A and 8B are block diagrams illustrating DCI formats for indicating an SRS transmission occasion where a single SRS resource set is configured, in accordance with aspects of the present disclosure. As shown in FIG. 8A, a DCI message 802 scheduling, for example a PUSCH message, may include an SRI field 804 along with a separate SRS transmission occasion indication field 806. In some cases, the SRS transmission occasion indication field 806 may use ┌log₂ N┐ bits to indicate the transmission occasion.

Alternately, as shown in FIG. 8B, a DCI message 852 for scheduling a PUSCH message may include an SRI field 854. The SRI field 854 may include the SRS transmission occasion indication 806. In such a case, the SRI field 854 and SRS transmission occasion indication 806 may be ┌log₂ N×M┐ bits, where M stands for the total number of SRI possibilities associated with the SRS resource set. In some cases, the total number of SRI possibilities may be based on a number of SRS per SRS transmission occasion and/or a maximum number of ranks considered by the UE.

In some cases, DCI message 802 and/or DCI message 852 may be based on an existing DCI format or a new DCI format. In some examples, DCI message 802 and/or DCI message 852 may used with a new radio network temporary identifier (RNTI) value for decoding the DCI message (e.g., DCI message 802 and/or DCI message 852). In some cases, the SRS resource set may be associated with a new usage in addition to the existing codebook usage and non-codebook usage, such as a nonCodebookTDPrediction usage, for the SRS resource set. In some cases, a new DCI format or RNTI value may be indicated where the UE is configured with an SRS resource set with a usage=nonCodebookTDPrediction. In some cases, the SRS resource set may be a set as a semi-persistent or periodical SRS resource set.

In some cases, different SRS transmission occasions can be associated with different sets of DL/UL-RSs for determining SRS spatial precoders. For example, a UE may be configured with N′ number of distinguished (e.g., distinct, different, etc.) and cyclic transmission occasions for the single SRS resource set. In some examples, the first transmission occasion may be identified after the SRS resource set is configured/activated or after the last transmission occasion has finished. In some cases, N′ may be greater than or equal to N. In some examples, the value of N′ may be determined based on a predefined value of N″, for example in a standard, based on a configuration from a network node (e.g., through RRC configuration of the SRS resource set, through a separate MAC-CE, etc.), based on a UE recommendation (e.g., UE may report, for example via a capability report, a maximum and/or minimum value of N as a UE capability and the network may configure (e.g., indicate) a value of N based on the report), based on a class of UE, and the like.

Where the UE is configured with distinguished and cyclic transmission occasions for the single SRS resource set, the transmission occasions may be associated with a transmission occasion specific associatedCSI-RS for the whole SRS resource set. In such cases, for each SRS transmission occasion, the associatedCSI-RS for the SRS resource set may be RRC configured for periodic (P) or semi-persistent (SP) SRS resource set or the associatedCSI-RS for the SRS resource set may be RRC configured in the SRS resource set with a candidate set of NZP-CSI-RSs, while a MAC-CE may be used to activate the SP SRS resource set and the MAC-CE may indicate the specific associatedCSI-RS for each transmission occasion to allow transmission occasion specific identification of precoders. In such cases, the UE may determine a precoder used for the transmission of the SRSs in the SRS resource set based on measurements of configured (e.g., indicated) in the NZP-CSI-RS resource for the respective SRS transmission occasions.

Where the UE is configured with distinguished and cyclic transmission occasions for the single SRS resource set, the transmission occasions may be associated with a transmission occasion specific spatialRelationInfo for different SRS resources of the SRS resource set. In some cases, for different SRS transmission occasions, the spatialRelationInfo for SRS resources in the SRS resource set may be configured. In some examples, a same spatial domain transmission filter used for the reception/transmission of the RS configured by the spatialRelationInfo associated with the SRS resource should be used for transmitting the SRS resource at the corresponding SRS transmission occasion. For example, if a particular spatial filter is used for downlink reception of the RS configured by spatialRelationInfo, then SRS resource may be transmitted using a reversed form of the spatial filter. If another spatial filter is used to transmit another SRS, then the same another spatial filter may be used to transmit the SRS. In some cases, the spatialRelationInfo may be included in CS-RS, a synchronization signal block (SSB), or another SRS.

In some cases, multiple SRS resource sets may be configured. The multiple SRS resource sets may be associated with different slot offsets and/or different slot periodicities. In some examples, an SRI may identify a particular SRS resource set (e.g., via an SRS resource set identifier). Where multiple SRS resources sets are configured, a DCI message may include an SRI and an SRS resource set identifier (ID) for an SRS transmission occasion prior to a PDCCH carrying the DCI. The SRS resource set indicated in the DCI may be associated with the most recent previous transmission occasion of the indicated SRS resource set. In some cases, a maximum value of N and/or a number of SRS resources in each SRS resource set may be based on a predefined value, for example in a standard, based on a configuration from a network node (e.g., through RRC configuration of the SRS resource set, through a separate MAC-CE, etc.), based on a UE recommendation (e.g., UE may report, for example via a capability report, a maximum and/or minimum value of N and/or a number of SRS resources in each SRS resource set as a UE capability and the network may configure (e.g., indicate) a value based on the report), based on a class of UE, and the like.

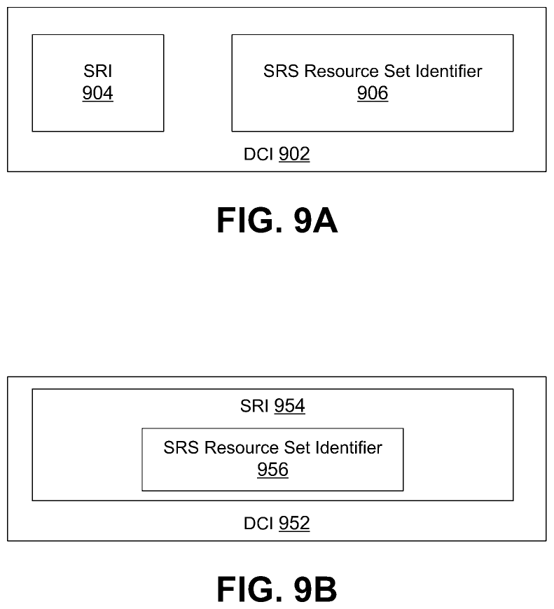

FIGS. 9A and 9B are block diagrams illustrating DCI formats for indicating an SRS transmission occasion where a multiple SRS resource sets are configured, in accordance with aspects of the present disclosure. As shown in FIG. 9A, a DCI message 902 scheduling, for example a PUSCH message, may include an SRI field 904 along with a separate SRS resource set ID field 906. In some cases, the SRS resource set ID field 906 may use ┌log₂ N┐ bits to indicate the SRS resource set. In some cases, each SRS resource set may include an equal number of SRS resources.

Alternatively, as shown in FIG. 9B, a DCI message 952 for scheduling a PUSCH message may include an SRI field 954. The SRI field 954 may include the SRS resource set ID 956. In some cases, each SRS resource set may include an equal number of SRS resources. In such a case, the SRI field 954 including the SRS resource set ID 956 may be ┌log₂ N×M┐ bits, where M stands for the total number of SRI possibilities associated with the SRS resource set.

In some cases, DCI message 902 and/or DCI message 952 may be based on an existing DCI format or a new DCI format. For example, DCI messages which include a selection of an SRS resource from an SRS transmission occasion prior to the most recent SRS transmission occasion may use a new DCI format and thus the format of the DCI message may be selected (e.g., by the network node) based on the DCI message including the selection of an SRS resource from an SRS transmission occasion prior to the most recent SRS transmission occasion. Similarly, the format of the DCI message may be selected (e.g., by the network node) based on new usage configured for the SRS resource set. In some examples, DCI message 902 and/or DCI message 952 may be used with a new radio network temporary identifier (RNTI) value for decoding the DCI message (e.g., DCI message 902 and/or DCI message 952). In some cases, the SRS resource set may be associated with a new usage in addition to the existing codebook usage and non-codebook usage, such as a nonCodebookTDPrediction usage, for the SRS resource set. In some cases, a new DCI format or RNTI value may be indicated where the UE is configured with an SRS resource set with a usage=nonCodebookTDPrediction. In some cases, SRS resource sets may be separately activated, for example, by a network node via a MAC-CE message. For example, a relatively large number of SRS resource sets may be configured, for example, via RRC, for a serving cell or a bandwidth part, and a subset of the configured SRS resource sets may be activated for use. The SRS resources sets referred to in the DCI message should be an activated SRS resource set. In some examples, the SRS resource set may be a set as a semi-persistent or periodical SRS resource set. In such cases, different SRS resource sets may include different slot offsets, but identical periodicities. In some cases, different SRS resource sets may be associated with different sets of DL or UL RSs for determining SRS spatial precoders.

In some cases, if a UE is configured to transmit a rank-2 (or higher) PUSCH, where the precoders are associated with two or more SRS resources from two different SRS transmission occasions or two or more different SRS resource sets, multiple SRS transmission occasions or multiple SRS resource sets may be indicated. In some cases, the SRI may be extended to address multiple different SRS transmission occasions or SRS resource sets (e.g., where a preferred precoder corresponds to an SRS transmission from different SRS transmission occasions). As an example, the DCI may indicate R previous SRS transmission occasions or SRS resource sets, where the {1^{st}, 2^{nd}, . . . , Rth} SRS resource (e.g., either the SRS transmission occasion or SRS resource set) associated with the SRI and indicated in the DCI, is associated with the corresponding indicated SRS transmission occasion or SRS resource set. As a more specific example with SRS resource sets, assuming a max-PUSCH-layer=4 PUSCH scheduling (e.g., max-rank=4), where one code-point indicates that no SRS resource set is selected for the corresponding layer, and where there are 7 SRS resource sets where each SRS resource set is comprised of 4 SRS resources, a certain SRS resource set for a certain layer may be indicated by ┌log₂ (7+1)┐=3 bits. The last code-point may be reserved, and the last code point may indicate that a precoder has not (or has) been picked for the corresponding layer. Thus, 3×4=12 bits in total of the DCI may be used to indicate SRS resource sets. In some cases, as max-rank-4, there may be one reserved code-point in each layer indicating that no SRS resource set is selected and that the corresponding layer is not supposed to be transmitted. The UE may map the SRS resource (indicated in SRI) for each of the {1^{st}, 2^{nd}, 3^{rd}, 4^{th}} indicated SRS resource set, to the DMRS port with the {1^{st}, 2^{nd}, 3^{rd}, 4^{th}} layer of the scheduled PUSCH. For example, The 1^{st} SRS resource in the 1^{st} chosen SRS resource set is used for the 1^{st} layer, the 2^{nd} SRS resource in the 2^{nd} chosen SRS resource set is used for the 2^{nd} layer, . . . , the 4^{th} SRS resource in the 4^{th} chosen SRS resource set is used for the 4^{th} layer. A total number of layers may be determined by the number of SRS resource sets indicated without a reserved bit-point (e.g., implicitly without a specific reserved bit indicating the number of SRS resource sets). In some cases, rather than using 12 bits in total, it may be possible to use

$$⌈ {log}_{2} [ ( \begin{matrix}7 \\ 4\end{matrix} ) + ( \begin{matrix}7 \\ 3\end{matrix} ) + ( \begin{matrix}7 \\ 2\end{matrix} ) + ( \begin{matrix}7 \\ 1\end{matrix} ) ] ⌉ = {log}_{2} ⌈ 98 ⌉ = 7$$

bits (where each component in the expression corresponds to selecting {4, 3, 2, 1} SRS resource sets out of the 7 configured ones) to indicate the identical information, assuming that the mapping order from SRS resource set to layer-ID can be based on SRS resource set's increasing/decreasing ID order.

In some cases, the techniques discussed above for referencing an SRS transmission occasion or an SRS resource set from multiple previous transmission occasions may be extended to PUSCH repetitions. For example, where the UL-grant DCI schedules multiple PUSCH repetitions, or schedules multiple SDM/FDM PUSCHs with multiple groups of SRS transmission occasions or multiple SRS resource sets, a DCI and SRI indication can be used which includes multiple different sets of indication that apply to different PUSCH repetitions. For example, where there is one received SRS resource set and the UL-grant DCI schedules multiple PUSCH repetitions, or schedules multiple SDM/FDM PUSCHs with multiple groups of SRS transmission occasions, the multiple PUSCH repetitions (or multiple SDM/FDM PUSCHs) may reference SRS resources of the one received SRS resource set. As another example, where there are multiple SRS resource sets, a DCI and SRI indication can be used which includes multiple different sets of indications that reference different SRS resource sets for different PUSCH repetitions.

In some cases, the techniques discussed above for referencing an SRS transmission occasion or an SRS resource set from multiple previous transmission occasions may be extended to codebook-based SRS and PUSCH. For codebook-based SRS, the UE may not generate precoders for the SRS transmission and the network node may indicate one or more precoders in a transmit precoder matrix indicator (TPMI) message to the UE for the PUSCH transmission. For example, referencing an SRS transmission occasion from multiple previous SRS transmission occasions for a non-codebook-based SRS resource set may be extended to codebook-based SRS resource sets by simply using a codebook-based SRS resource set rather than a non-codebook based SRS resource set. Similarly, referencing an SRS resource set from multiple previous SRS transmission occasions for multiple non-codebook-based SRS resource sets may be extended to codebook-based SRS resource sets by simply using multiple codebook-based SRS resource sets, where all of the SRS resource sets are codebook based. In the case of codebook-based SRS resource set(s), the SRI indication used for non-codebook-based SRS and PUSCH may be replaced by an SRI and TPMI indication for codebook-based SRS and PUSCH.

The techniques discussed above for referencing an SRS transmission occasion or an SRS resource set from multiple previous transmission occasions may be extended to uplink transmission configuration indicator state (UL-TCI State) switching, in some examples. As an example, a UE may be configured with one or more SRS resource sets and for a UL-TCI State associated with a particular SRS resource, a MAC-CE activating the UL-TCI State may further indicate the SRS occasion associated with the SRS resource. Candidates for the SRS transmission occasion may be based on multiple previous SRS transmission occasions. The multiple previous SRS transmission occasions may be based on a single SRS resource set or multiple SRS resource sets. Where the multiple previous SRS transmission occasions are based on a single SRS resource set, the MAC-CE indication may additionally identify the SRS transmission occasion. Where the multiple previous SRS transmission occasions are based on multiple SRS resource sets, the multiple SRS resource sets may be associated with different slot-offsets and/or periodicities, and the MAC-CE indication may identify the SRS resource set ID. Similarly, the value of N may be determined based on a predefined value of N, for example in a standard, based on a configuration from a network node (e.g., through RRC configuration of the SRS resource set, through a separate MAC-CE, etc.), based on a UE recommendation (e.g., UE may report, for example via a capability report, a maximum and/or minimum value of N as a UE capability and the network may configure (e.g., indicate) a value of N based on the report), based on a class of UE, and the like.

In some cases, it may be useful to help a network node (e.g., gNB) obtain a better information about SRS beam characteristics of a UE. To help the network node obtain UE SRS beam characteristics, the UE may explicitly report transmission beam characteristics for SRS transmissions, such as beam-pointing direction, width, beamforming gain, which transmission beam was used for transmitting an SRS resource, and the like, to the network node. In some cases, the reporting may be based on a transmission beam cycling pattern. This transmission beam cycling patterns may be reported via RRC/MAC-CE messages. In some cases, this reporting may be performed dynamically (e.g., via UCI) to indicate the transmission beam(s) used in a most recent previous SRS transmission.

In some cases, it may be useful not to explicitly report transmission beam characteristics, for example, to save bandwidth or to avoid directly disclosing performance information about a UE. In some examples, an AI/ML model may be used for network node side uplink beam prediction may be trained by a UE vendor and obtained by the network node. In some cases, the trained AI/ML models may be obtained by the network node from vendor or third-party servers (e.g., servers hosting the trained AI/ML models) or preloaded/pushed onto the network node. In some cases, input to the AI/ML model may be measurements of the SRS transmissions on SRS resources from the UE (and optionally the transmission beam ID associated with the SRS transmission), and output of the AI/ML mode may be predicted UL precoders for future time occasions. In some cases, the UE may report beam IDs (e.g., via RRC/MAC-CE messaging as cycling patterns or dynamically reported via UCI). In some cases, multiple AI/ML models may be trained and provided by UE vendors. The different AI/ML models may be associated with different numbers of SRS transmission occasions or SRS resource sets.

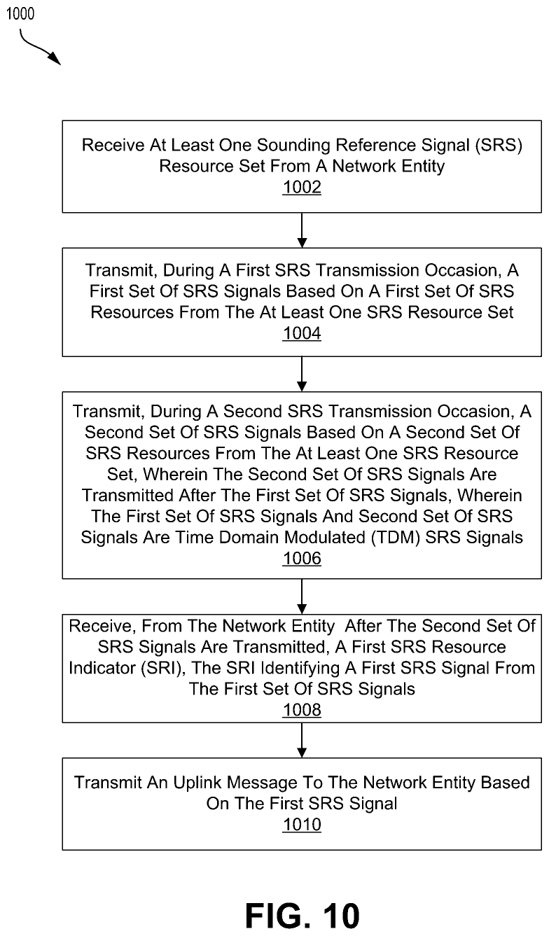

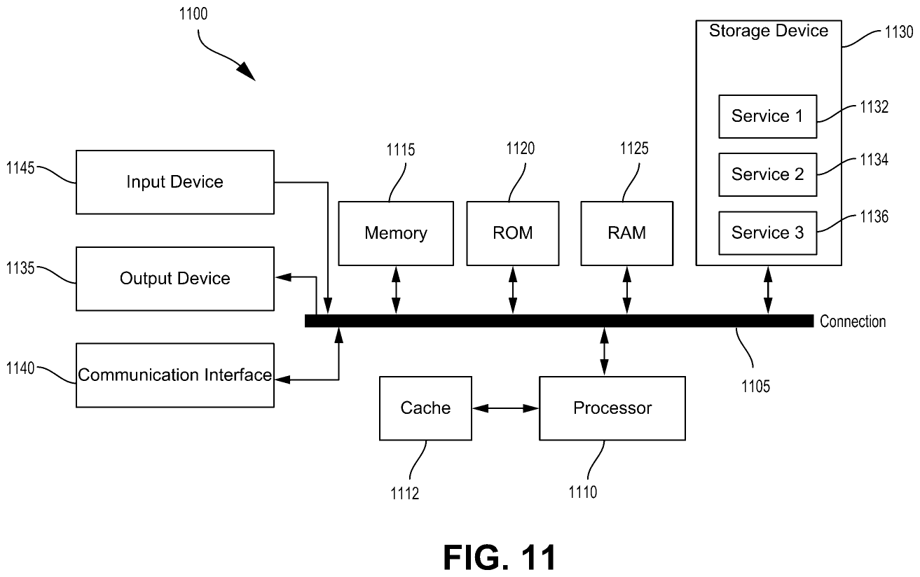

FIG. 10 is a flow diagram illustrating a process 1000 for performing wireless communications. The process 1000 can be performed by a component or system (e.g., a chipset) of a wireless device (e.g., UE 104, UE 702, of FIGS. 1 and 2, respectively, and computing system 11 of FIG. 11). The wireless device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1000 may be implemented as software components that are executed and run on one or more processors (e.g., processor 484 of FIG. 4, processor 1110 of FIG. 11 or other processor(s)). Further, the transmission and reception of signals by the wireless device in the process 1000 may be enabled, for example, by one or more antennas (e.g., antennas 252 of FIG. 2, antenna 487 of FIG. 4) and/or one or more transceivers (e.g., wireless transceiver(s) 478 of FIG. 4).

At block 1002, the computing device (or component thereof) may receive an indication of at least one sounding reference signal (SRS) resource set from a network entity (e.g., BS 102, mmWBS 180, AP 150 of FIG. 1, BS 102 of FIG. 2, RU 340 of FIG. 3). For example, a UE may receive an SRS resource set from a network node. In some cases, the computing device (or component thereof) may receive one SRS resource set, and wherein the multiple repetitions reference different SRS resources of the one SRS resource set. For example, where there is one received SRS resource set and the UL-grant DCI schedules multiple PUSCH repetitions, or schedules multiple SDM/FDM PUSCHs with multiple groups of SRS transmission occasions, the multiple PUSCH repetitions (or multiple SDM/FDM PUSCHs) may reference SRS resources of the one received SRS resource set. In some cases, the computing device (or component thereof) may receive one SRS resource set, wherein the one SRS resource set is a semi-persistent SRS resource set or a periodic SRS resource set. In some cases, the computing device (or component thereof) may receive a plurality of SRS resource sets, and wherein the multiple repetitions reference different SRS resource sets. For example, with multiple SRS resource sets, a DCI and SRI indication can be used which includes multiple different sets of indications that reference different SRS resource sets for different PUSCH repetitions. In some cases, the computing device (or component thereof) may receive a plurality of SRS resource sets, wherein the plurality of SRS resource sets are semi-persistent. In some cases, the computing device (or component thereof) may receive a plurality of SRS resource sets, wherein the plurality of SRS resource sets are periodical, and wherein SRS resource sets of the plurality of SRS resource sets include different slot offsets. In some cases, the computing device (or component thereof) may receive a plurality of SRS resource sets, wherein SRS resource sets of the plurality of SRS resource sets are associated with different sets of reference signals for determining SRS spatial precoders. For example, different SRS resource sets may be associated with different sets of DL or UL RSs for determining SRS spatial precoders. In some cases, the computing device (or component thereof) may receive the at least one SRS resource set, the at least one processor is configured to receive a single SRS resource set, and wherein the at least one processor is further configured to receive a set of distinguished cyclic transmission occasions for the SRS resource set. For example, a UE may be configured with N′ number of distinguished (e.g., distinct, different, etc.) and cyclic transmission occasions for the single SRS resource set. In some cases, a channel state information reference signal (CSI-RS) is set for each transmission occasion of the set of distinguished cyclic transmission occasions. For example, a transmission occasion may be associated with a transmission occasion specific associatedCSI-RS. In some cases, the computing device (or component thereof) may receive a plurality of SRS resource sets, wherein the plurality of SRS resource sets are associated with at least one of: different slot offsets, or different periodicities; wherein the second set of SRS signals are transmitted based on a different SRS resource set as compared to the first set of SRS signals. In some cases, the at least one SRS resource set comprises non-codebook-based SRS resource sets. In some cases, the at least one SRS resource set comprises codebook-based SRS resource sets, and wherein the at least one processor is further configured to receive an indication of a transmit precoder matrix indicator (TPMI). For example, for codebook based SRS, a UE may not generate precoders for SRS transmissions and may receive one or more precoders in a TPMI message.

At block 1004, the computing device (or component thereof) may transmit, during a first SRS transmission occasion, a first set of SRS signals based on a first set of SRS resources from the at least one SRS resource set. In some cases, the computing device (or component thereof) may configure different spatial domain transmission filters for different SRS resources of the single SRS resource set. For example, spatialRelationInfo may be included in CS-RS, a synchronization signal block (SSB), or another SRS, and the spatialRelationInfo may indicate a spatial domain transmission filter for different SRS resources. In some cases, the computing device (or component thereof) may report transmission beam characteristics associated for transmitting SRS signals. For example, the UE may explicitly report transmission beam characteristics for SRS transmissions, such as beam-pointing direction, width, beamforming gain, which transmission beam was used for transmitting an SRS resource, and the like, to the network node.

At block 1006, the computing device (or component thereof) may transmit, during a second SRS transmission occasion, a second set of SRS signals based on a second set of SRS resources from the at least one SRS resource set, wherein the second set of SRS signals are transmitted after the first set of SRS signals, wherein the first set of SRS signals and second set of SRS signals are time division multiplexed (TDM) SRS signals.

At block 1008, the computing device (or component thereof) may receive, from the network entity after the second set of SRS signals are transmitted, a first SRS resource indicator (SRI), the SRI identifying a first SRS signal from the first set of SRS signals. In some cases, the first SRI identifies the first SRS signal based on the first SRS transmission occasion. For example, the first SRI may identify a particular SRS transmission occasion. In some cases, the first SRS transmission occasion occurs within a predefined number of transmissions occasions. For example, the message may include an indication of a number N of most recent transmission occasions of the single SRS resource set that may be referred to. In some cases, the first SRI is transmitted in a field of a downlink control information (DCI) message, such as DCI 802 or DCI 852 of FIGS. 8A and 8B, respectively. In some cases, an indication of the first SRS transmission occasion is transmitted in a field separate from the first SRI in the DCI message, such as in DCI 802 of FIG. 8A. In some cases, an indication of the first SRS transmission occasion is transmitted in a field of the first SRI in the DCI message, such as in DCI 852 of FIG. 8B. In some cases, a format of the DCI message is based on the DCI message including the SRI identifying a first SRS signal. For example, a different (e.g., different from a DCI format in 5G Rel. 17) DCI format may be used when the DCI includes a selection of an SRS resource from an SRS transmission occasion prior to the most recent SRS transmission occasion. In some cases, the at least one SRS resource set is associated with a usage configured for the at least one SRS resource set. For example, the SRS resource set may be associated with a nonCodebookTDPrediction usage. In some cases, a format of the DCI message is based on the DCI message including the usage. For example, a different (e.g., different from a DCI format in 5G Rel. 17) DCI format may be used when the DCI includes a nonCodebookTDPrediction usage. In some cases, the DCI message includes scheduling information for multiple repetitions for a shared uplink channel. In some cases, the first SRI identifies the first SRS signal based on an SRS resource set identifier. In some cases, the first SRI is transmitted in a field of a downlink control information (DCI) message, and wherein the SRS resource set identifier is indicated in the DCI message (e.g., DCI 802 of FIG. 8A and/or DCI 852 of FIG. 8B). In some cases, the SRS resource set identifier is in a field separate from the first SRI in the DCI message (e.g., DCI 802 of FIG. 8A). In some cases, the SRS resource set identifier is in a field of the first SRI in the DCI message (e.g., DCI 852 of FIG. 8B). In some cases, the first SRI identifies SRS signals from multiple SRS resource sets. For example, the different SRS resource sets may be associated with different resources for transmitting SRS, such as different slot-offsets, periodicities, etc. In some cases, first SRI identifies SRS signals from multiple previous SRS transmission occasions. For example, if UE is configured to transmit a rank-2 (or higher) PUSCH, where the precoders are associated with two or more SRS resources from two different SRS transmission occasions or two or more different SRS resource sets, multiple SRS transmission occasions or multiple SRS resource sets may be indicated. In some cases, the computing device (or component thereof) may receive a medium access control (MAC) control element (MAC-CE) message indicating an uplink transmission configuration indicator (UL-TCI) state, wherein the UL-TCI state is associated with an SRS resource, wherein the MAC-CE indicates a previous SRS transmission occasion associated with the SRS resource; and transmit the uplink message based on the UL-TCI state and the SRS resource of the previous SRS transmission occasion. In some cases, the computing device (or component thereof) may receive a medium access control (MAC) control element (MAC-CE) message indicating an uplink transmission configuration indicator (UL-TCI) state, wherein the UL-TCI state is associated with an SRS resource, wherein the MAC-CE includes an SRS resource set identifier; and transmit the uplink message based on the UL-TCI state and the SRS resource set identifier.

At block 1010, the computing device (or component thereof) may transmit an uplink message to the network entity based on the first SRS signal.

FIG. 11 is a diagram illustrating an example of a system for implementing certain aspects of the present technology. In particular, FIG. 11 illustrates an example of computing system, which may be for example any computing device making up internal computing system, a remote computing system, a camera, or any component thereof in which the components of the system are in communication with each other using connection 1105. Connection 1105 may be a physical connection using a bus, or a direct connection into processor 1110, such as in a chipset architecture. Connection 1105 may also be a virtual connection, networked connection, or logical connection.

In some embodiments, computing system 1100 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1100 includes at least one processing unit (CPU or processor) 1110 and connection 1105 that communicatively couples various system components including system memory 1115, such as read-only memory (ROM) 1120 and random access memory (RAM) 1125 to processor 1110. Computing system 1100 may include a cache 1112 of high-speed memory connected directly with, in close proximity to, or integrated as part of processor 1110.

Processor 1110 may include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which may represent any number of input mechanisms, such as a microphone for speech, a touch-sensitive screen for gesture or graphical input, keyboard, mouse, motion input, speech, etc. Computing system 1100 may also include output device 1135, which may be one or more of a number of output mechanisms. In some instances, multimodal systems may enable a user to provide multiple types of input/output to communicate with computing system 1100.

Computing system 1100 may include communications interface 1140, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1130 may include software services, servers, services, etc., that when the code that defines such software is executed by the processor 1110, it causes the system to perform a function. In some embodiments, a hardware service that performs a particular function may include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative aspects of the disclosure include:

Aspect 1. An apparatus for wireless communications by a user equipment (UE), comprising: at least one memory; and at least one processor coupled to the at least one memory and configured to: receive an indication of at least one sounding reference signal (SRS) resource set from a network entity; transmit, during a first SRS transmission occasion, a first set of SRS signals based on a first set of SRS resources from the at least one SRS resource set; transmit, during a second SRS transmission occasion, a second set of SRS signals based on a second set of SRS resources from the at least one SRS resource set, wherein the second set of SRS signals are transmitted after the first set of SRS signals, wherein the first set of SRS signals and second set of SRS signals are time division multiplexed (TDM) SRS signals; receive, from the network entity after the second set of SRS signals are transmitted, a first SRS resource indicator (SRI), the SRI identifying a first SRS signal from the first set of SRS signals; and transmit an uplink message to the network entity based on the first SRS signal.

Aspect 2. The apparatus of Aspect 1, wherein the first SRI identifies the first SRS signal based on the first SRS transmission occasion.

Aspect 3. The apparatus of Aspect 2, wherein the first SRS transmission occasion occurs within a predefined number of transmissions occasions.

Aspect 4. The apparatus of any of Aspects 2-3, wherein the first SRI is transmitted in a field of a downlink control information (DCI) message.

Aspect 5. The apparatus of Aspect 4, wherein an indication of the first SRS transmission occasion is transmitted in a field separate from the first SRI in the DCI message.

Aspect 6. The apparatus of Aspect 4, wherein an indication of the first SRS transmission occasion is transmitted in a field of the first SRI in the DCI message.

Aspect 7. The apparatus of any of Aspects 4-6, wherein a format of the DCI message is based on the DCI message including the SRI identifying a first SRS signal.

Aspect 8. The apparatus of any of Aspects 4-7, wherein the at least one SRS resource set is associated with a usage configured for the at least one SRS resource set.

Aspect 9. The apparatus of Aspect 8, wherein a format of the DCI message is based on the DCI message including the usage.

Aspect 10. The apparatus of any of Aspects 4-9, wherein the DCI message includes scheduling information for multiple repetitions for a shared uplink channel.

Aspect 11. The apparatus of Aspect 10, wherein the at least one processor is further configured to receive one SRS resource set, and wherein the multiple repetitions reference different SRS resources of the one SRS resource set.

Aspect 12. The apparatus of Aspect 10, wherein the at least one processor is configured to receive a plurality of SRS resource sets, and wherein the multiple repetitions reference different SRS resource sets.

Aspect 13. The apparatus of any of Aspects 1-11, wherein the at least one processor is further configured to receive one SRS resource set, wherein the one SRS resource set is a semi-persistent SRS resource set or a periodic SRS resource set.

Aspect 14. The apparatus of any of Aspects 1-10 and 12, wherein the at least one processor is further configured to receive a plurality of SRS resource sets, wherein the plurality of SRS resource sets are semi-persistent.

Aspect 15. The apparatus of any of Aspects 1-10 and 12, wherein the at least one processor is further configured to receive a plurality of SRS resource sets, wherein the plurality of SRS resource sets are periodical, and wherein SRS resource sets of the plurality of SRS resource sets include different slot offsets.

Aspect 16. The apparatus of any of Aspects 1-10, 12, and 15, wherein the at least one processor is further configured to receive a plurality of SRS resource sets, wherein SRS resource sets of the plurality of SRS resource sets are associated with different sets of reference signals for determining SRS spatial precoders.

Aspect 17. The apparatus of any of Aspects 1-11 and 13, wherein, to receive the at least one SRS resource set, the at least one processor is configured to receive a single SRS resource set, and wherein the at least one processor is further configured to receive a set of distinguished cyclic transmission occasions for the SRS resource set.

Aspect 18. The apparatus of Aspect 17, wherein a channel state information reference signal (CSI-RS) is set for each transmission occasion of the set of distinguished cyclic transmission occasions.

Aspect 19. The apparatus of Aspect 17, wherein the at least one processor is further configured to configure different spatial domain transmission filters for different SRS resources of the single SRS resource set.

Aspect 20. The apparatus of any of Aspects 1-10, 12, and 14-16, wherein the at least one processor is further configured to receive a plurality of SRS resource sets, wherein the plurality of SRS resource sets are associated with at least one of: different slot offsets, or different periodicities; wherein the second set of SRS signals are transmitted based on a different SRS resource set as compared to the first set of SRS signals.

Aspect 21. The apparatus of Aspect 20, wherein the first SRI identifies the first SRS signal based on an SRS resource set identifier.

Aspect 22. The apparatus of Aspect 21, wherein the first SRI is transmitted in a field of a downlink control information (DCI) message, and wherein the SRS resource set identifier is indicated in the DCI message.

Aspect 23. The apparatus of Aspect 22, wherein the SRS resource set identifier is in a field separate from the first SRI in the DCI message.

Aspect 24. The apparatus of Aspect 22, wherein the SRS resource set identifier is in a field of the first SRI in the DCI message.

Aspect 25. The apparatus of Aspect 24, wherein the first SRI identifies SRS signals from multiple SRS resource sets.

Aspect 26. The apparatus of any of Aspects 1-25, wherein the first SRI identifies SRS signals from multiple previous SRS transmission occasions.

Aspect 27. The apparatus of any of Aspects 1-26, wherein the at least one processor is further configured to report transmission beam characteristics associated for transmitting SRS signals.

Aspect 28. The apparatus of any of Aspects 1-27, wherein the at least one SRS resource set comprises non-codebook-based SRS resource sets.

Aspect 29. The apparatus of any of Aspects 1-27, wherein the at least one SRS resource set comprises codebook-based SRS resource sets, and wherein the at least one processor is further configured to receive an indication of a transmit precoder matrix indicator (TPMI).

Aspect 30. The apparatus of any of Aspects 1-29, wherein the at least one processor is further configured to: receive a medium access control (MAC) control element (MAC-CE) message indicating an uplink transmission configuration indicator (UL-TCI) state, wherein the UL-TCI state is associated with an SRS resource, wherein the MAC-CE indicates a previous SRS transmission occasion associated with the SRS resource; and transmit the uplink message based on the UL-TCI state and the SRS resource of the previous SRS transmission occasion.

Aspect 31. The apparatus of any of Aspects 1-29, wherein the at least one processor is further configured to: receive a medium access control (MAC) control element (MAC-CE) message indicating an uplink transmission configuration indicator (UL-TCI) state, wherein the UL-TCI state is associated with an SRS resource, wherein the MAC-CE includes an SRS resource set identifier; and transmit the uplink message based on the UL-TCI state and the SRS resource set identifier.

Aspect 32. A method of wireless communications performed by a user equipment (UE), comprising: receiving an indication of at least one sounding reference signal (SRS) resource set from a network entity; transmitting, during a first SRS transmission occasion, a first set of SRS signals based on a first set of SRS resources from the at least one SRS resource set; transmitting, during a second SRS transmission occasion, a second set of SRS signals based on a second set of SRS resources from the at least one SRS resource set, wherein the second set of SRS signals are transmitted after the first set of SRS signals, wherein the first set of SRS signals and second set of SRS signals are time division multiplexed (TDM) SRS signals; receiving, from the network entity after the second set of SRS signals are transmitted, a first SRS resource indicator (SRI), the SRI identifying a first SRS signal from the first set of SRS signals; and transmitting an uplink message to the network entity based on the first SRS signal.

Aspect 33. The method of Aspect 32, wherein the first SRI identifies the first SRS signal based on the first SRS transmission occasion.

Aspect 34. The method of Aspect 33, wherein the first SRS transmission occasion occurs within a predefined number of transmissions occasions.

Aspect 35. The method of any of Aspects 33-34, wherein the first SRI is transmitted in a field of a downlink control information (DCI) message.

Aspect 36. The method of Aspect 35, wherein an indication of the first SRS transmission occasion is transmitted in a field separate from the first SRI in the DCI message.

Aspect 37. The method of Aspect 35, wherein an indication of the first SRS transmission occasion is transmitted in a field of the first SRI in the DCI message.

Aspect 38. The method of any of Aspects 35-37, wherein a format of the DCI message is based on the DCI message including the SRI identifying a first SRS signal.

Aspect 39. The method of any of Aspects 35-38, wherein the at least one SRS resource set is associated with a usage configured for the at least one SRS resource set.

Aspect 40. The method of Aspect 39, wherein a format of the DCI message is based on the DCI message including the usage.

Aspect 41. The method of any of Aspects 35-40, wherein the DCI message includes scheduling information for multiple repetitions for a shared uplink channel.

Aspect 42. The method of Aspect 41, further comprising receiving one SRS resource set, and wherein the multiple repetitions reference different SRS resources of the one SRS resource set.

Aspect 43. The method of Aspect 41, further comprising receiving a plurality of SRS resource sets, and wherein the multiple repetitions reference different SRS resource sets.

Aspect 44. The method of any of Aspects 32-42, further comprising receiving one SRS resource set, wherein the one SRS resource set is a semi-persistent SRS resource set or a periodic SRS resource set.

Aspect 45. The method of any of Aspects 32-41 and 43, further comprising receiving a plurality of SRS resource sets, wherein the plurality of SRS resource sets are semi-persistent.

Aspect 46. The method of any of Aspects 32-41 and 43, further comprising receiving a plurality of SRS resource sets, wherein the plurality of SRS resource sets are periodical, and wherein SRS resource sets of the plurality of SRS resource sets include different slot offsets.

Aspect 47. The method of any of Aspects 32-41, 43, and 46, further comprising receiving a plurality of SRS resource sets, wherein SRS resource sets of the plurality of SRS resource sets are associated with different sets of reference signals for determining SRS spatial precoders.

Aspect 48. The method of any of Aspects 32-42 and 44, wherein receiving the at least one SRS resource set comprising receiving a single SRS resource set, and further comprising receiving a set of distinguished cyclic transmission occasions for the SRS resource set.

Aspect 49. The method of Aspect 48, wherein a channel state information reference signal (CSI-RS) is set for each transmission occasion of the set of distinguished cyclic transmission occasions.

Aspect 50. The method of Aspect 48, further comprising configuring different spatial domain transmission filters for different SRS resources of the single SRS resource set.

Aspect 51. The method of any of Aspects 32-41, 43, and 45-47, further comprising receiving a plurality of SRS resource sets, wherein the plurality of SRS resource sets are associated with at least one of: different slot offsets, or different periodicities; wherein the second set of SRS signals are transmitted based on a different SRS resource set as compared to the first set of SRS signals.

Aspect 52. The method of Aspect 51, wherein the first SRI identifies the first SRS signal based on an SRS resource set identifier.

Aspect 53. The method of Aspect 52, wherein the first SRI is transmitted in a field of a downlink control information (DCI) message, and wherein the SRS resource set identifier is indicated in the DCI message.

Aspect 54. The method of Aspect 53, wherein the SRS resource set identifier is in a field separate from the first SRI in the DCI message.

Aspect 55. The method of Aspect 53, wherein the SRS resource set identifier is in a field of the first SRI in the DCI message.

Aspect 56. The method of Aspect 55, wherein the first SRI identifies SRS signals from multiple SRS resource sets.

Aspect 57. The method of any of Aspects 32-56, wherein the first SRI identifies SRS signals from multiple previous SRS transmission occasions.

Aspect 58. The method of any of Aspects 32-57, further comprising reporting transmission beam characteristics associated for transmitting SRS signals.

Aspect 59. The method of any of Aspects 32-58, wherein the at least one SRS resource set comprises non-codebook-based SRS resource sets.

Aspect 60. The method of any of Aspects 32-58, wherein the at least one SRS resource set comprises codebook-based SRS resource sets, and further comprising receiving an indication of a transmit precoder matrix indicator (TPMI).

Aspect 61. The method of any of Aspects 32-60, further comprising: receiving a medium access control (MAC) control element (MAC-CE) message indicating an uplink transmission configuration indicator (UL-TCI) state, wherein the UL-TCI state is associated with an SRS resource, wherein the MAC-CE indicates a previous SRS transmission occasion associated with the SRS resource; and transmitting the uplink message based on the UL-TCI state and the SRS resource of the previous SRS transmission occasion.

Aspect 62. The method of any of Aspects 32-60, further comprising: receiving a medium access control (MAC) control element (MAC-CE) message indicating an uplink transmission configuration indicator (UL-TCI) state, wherein the UL-TCI state is associated with an SRS resource, wherein the MAC-CE includes an SRS resource set identifier; and transmitting the uplink message based on the UL-TCI state and the SRS resource set identifier.

Aspect 63. An apparatus for wireless communications by a network entity, comprising: at least one memory; and at least one processor coupled to the at least one memory and configured to: transmit an indication of at least one sounding reference signal (SRS) resource set to a user equipment (UE); receive, during a first SRS transmission occasion, a first set of SRS signals based on a first set of SRS resources from the at least one SRS resource set; receive, during a second SRS transmission occasion, a second set of SRS signals based on a second set of SRS resources from the at least one SRS resource set, wherein the second set of SRS signals are transmitted after the first set of SRS signals, wherein the first set of SRS signals and second set of SRS signals are time division multiplexed (TDM) SRS signals; determine, a first SRS resource indicator (SRI), the SRI identifying a first SRS signal from the first set of SRS signals; transmit, to the UE after the second set of SRS signals are received, the first SRS SRI; and receive an uplink message from the UE based on the first SRS signal.

Aspect 64. The apparatus of Aspect 63, wherein the first SRI identifies the first SRS signal based on the first SRS transmission occasion.

Aspect 65. The apparatus of Aspect 64, wherein the first SRS transmission occasion occurs within a predefined number of transmissions occasions.

Aspect 66. The apparatus of any of Aspects 64-65, wherein the first SRI is in a field of a downlink control information (DCI) message.

Aspect 67. The apparatus of Aspect 66, wherein an indication of the first SRS transmission occasion is in a field separate from the first SRI in the DCI message.

Aspect 68. The apparatus of Aspect 66, wherein an indication of the first SRS transmission occasion is in a field of the first SRI in the DCI message.

Aspect 69. The apparatus of any of Aspects 66-68, wherein a format of the DCI message is based on the DCI message including the SRI identifying a first SRS signal.

Aspect 70. The apparatus of any of Aspects 66-69, wherein the at least one SRS resource set is associated with a usage configured for the at least one SRS resource set.

Aspect 71. The apparatus of Aspect 70, wherein a format of the DCI message is based on the DCI message including the usage.

Aspect 72. The apparatus of any of Aspects 66-71, wherein the DCI message includes scheduling information for multiple repetitions for a shared uplink channel.

Aspect 73. The apparatus of Aspect 72, wherein the at least one processor is further configured to transmit one SRS resource set, and wherein the multiple repetitions reference different SRS resources of the one SRS resource set.

Aspect 74. The apparatus of Aspect 72, wherein the at least one processor is configured to receive a plurality of SRS resource sets, and wherein the multiple repetitions reference different SRS resource sets.

Aspect 75. The apparatus of any of Aspects 63-73, wherein the at least one processor is further configured to transmit one SRS resource set, wherein the one SRS resource set is a semi-persistent SRS resource set or a periodic SRS resource set.

Aspect 76. The apparatus of any of Aspects 63-72 and 74, wherein the at least one processor is further configured to transmit a plurality of SRS resource sets, wherein the plurality of SRS resource sets are semi-persistent.

Aspect 77. The apparatus of any of Aspects 63-72 and 12, wherein the at least one processor is further configured to transmit a plurality of SRS resource sets, wherein the plurality of SRS resource sets are periodical, and wherein SRS resource sets of the plurality of SRS resource sets include different slot offsets.

Aspect 78. The apparatus of any of Aspects 63-72, 74, and 77, wherein the at least one processor is further configured to transmit a plurality of SRS resource sets, wherein SRS resource sets of the plurality of SRS resource sets are associated with different sets of reference signals for determining SRS spatial precoders.

Aspect 79. The apparatus of any of Aspects 63-73 and 75, wherein, to transmit the at least one SRS resource set, the at least one processor is configured to transmit a single SRS resource set, and wherein the at least one processor is further configured to transmit a set of distinguished cyclic transmission occasions for the SRS resource set.

Aspect 80. The apparatus of Aspect 79, wherein a channel state information reference signal (CSI-RS) is set for each transmission occasion of the set of distinguished cyclic transmission occasions.

Aspect 81. The apparatus of any of Aspects 63-72, 74, and 76-78, wherein the at least one processor is further configured to transmit a plurality of SRS resource sets, wherein the plurality of SRS resource sets are associated with at least one of: different slot offsets, or different periodicities; wherein the second set of SRS signals are received based on a different SRS resource set as compared to the first set of SRS signals.

Aspect 82. The apparatus of Aspect 81, wherein the first SRI identifies the first SRS signal based on an SRS resource set identifier.

Aspect 83. The apparatus of Aspect 82, wherein the first SRI is received in a field of a downlink control information (DCI) message, and wherein the SRS resource set identifier is indicated in the DCI message.

Aspect 84. The apparatus of Aspect 83, wherein the SRS resource set identifier is in a field separate from the first SRI in the DCI message.

Aspect 85. The apparatus of Aspect 83, wherein the SRS resource set identifier is in a field of the first SRI in the DCI message.

Aspect 86. The apparatus of Aspect 85, wherein the first SRI identifies SRS signals from multiple SRS resource sets.

Aspect 87. The apparatus of any of Aspects 63-86, wherein the first SRI identifies SRS signals from multiple previous SRS transmission occasions.

Aspect 88. The apparatus of any of Aspects 63-87, wherein the at least one processor is further configured to receive a report for transmission beam characteristics associated with SRS signals.

Aspect 89. The apparatus of any of Aspects 63-88, wherein the at least one SRS resource set comprises non-codebook-based SRS resource sets.

Aspect 90. The apparatus of any of Aspects 63-88, wherein the at least one SRS resource set comprises codebook-based SRS resource sets, and wherein the at least one processor is further configured to transmit an indication of a transmit precoder matrix indicator (TPMI).

Aspect 91. The apparatus of any of Aspects 63-90, wherein the at least one processor is further configured to: transmit a medium access control (MAC) control element (MAC-CE) message indicating an uplink transmission configuration indicator (UL-TCI) state, wherein the UL-TCI state is associated with an SRS resource, wherein the MAC-CE indicates a previous SRS transmission occasion associated with the SRS resource; and receive the uplink message based on the UL-TCI state and the SRS resource of the previous SRS transmission occasion.

Aspect 92. The apparatus of any of Aspects 63-91, wherein the at least one processor is further configured to: transmit a medium access control (MAC) control element (MAC-CE) message indicating an uplink transmission configuration indicator (UL-TCI) state, wherein the UL-TCI state is associated with an SRS resource, wherein the MAC-CE includes an SRS resource set identifier; and receive the uplink message based on the UL-TCI state and the SRS resource set identifier.

Aspect 93. A method for wireless communications comprising performing operations according to any of Aspects 63-92 and 96.

Aspect 94. A non-transitory computer-readable storage medium comprising instructions stored thereon which, when executed by at least one processor, causes the at least one processor to perform operations according to any of Aspects 32-92 and 96.

Aspect 95. An apparatus for wireless communications comprising one or more means for performing operations according to any of Aspects 32-92 and 96.

Aspect 96. The apparatus of Aspect 63, wherein the at least one processor is further configured to receive transmission beam characteristics for SRS transmissions of a user device.

1. An apparatus for wireless communications by a user equipment (UE), comprising:
at least one memory; and
at least one processor coupled to the at least one memory and configured to:
receive an indication of at least one sounding reference signal (SRS) resource set from a network entity;
transmit, during a first SRS transmission occasion, a first set of SRS signals based on a first set of SRS resources from the at least one SRS resource set;
transmit, during a second SRS transmission occasion, a second set of SRS signals based on a second set of SRS resources from the at least one SRS resource set, wherein the second set of SRS signals are transmitted after the first set of SRS signals, wherein the first set of SRS signals and second set of SRS signals are time division multiplexed (TDM) SRS signals;
receive, from the network entity after the second set of SRS signals are transmitted, a first SRS resource indicator (SRI), the SRI identifying a first SRS signal from the first set of SRS signals; and
transmit an uplink message to the network entity based on the first SRS signal.

2. The apparatus of claim 1, wherein the first SRI identifies the first SRS signal based on the first SRS transmission occasion.

3. The apparatus of claim 2, wherein the first SRS transmission occasion occurs within a predefined number of transmissions occasions.

4. The apparatus of claim 2, wherein the first SRI is transmitted in a field of a downlink control information (DCI) message.

5. The apparatus of claim 4, wherein an indication of the first SRS transmission occasion is transmitted in a field separate from the first SRI in the DCI message.

6. The apparatus of claim 4, wherein an indication of the first SRS transmission occasion is transmitted in a field of the first SRI in the DCI message.

7. The apparatus of claim 4, wherein a format of the DCI message is based on the DCI message including the SRI identifying a first SRS signal.

8. The apparatus of claim 4, wherein the at least one SRS resource set is associated with a usage configured for the at least one SRS resource set.

9. The apparatus of claim 8, wherein a format of the DCI message is based on the DCI message including the usage.

10. The apparatus of claim 4, wherein the DCI message includes scheduling information for multiple repetitions for a shared uplink channel.

11. The apparatus of claim 10, wherein the at least one processor is further configured to receive one SRS resource set, and wherein the multiple repetitions reference different SRS resources of the one SRS resource set.

12. The apparatus of claim 10, wherein the at least one processor is configured to receive a plurality of SRS resource sets, and wherein the multiple repetitions reference different SRS resource sets.

13. The apparatus of claim 1, wherein the at least one processor is further configured to receive one SRS resource set, wherein the one SRS resource set is a semi-persistent SRS resource set or a periodic SRS resource set.

14. The apparatus of claim 1, wherein the at least one processor is further configured to receive a plurality of SRS resource sets, wherein the plurality of SRS resource sets are semi-persistent.

15. The apparatus of claim 1, wherein the at least one processor is further configured to receive a plurality of SRS resource sets, wherein the plurality of SRS resource sets are periodical, and wherein SRS resource sets of the plurality of SRS resource sets include different slot offsets.

16. The apparatus of claim 1, wherein the at least one processor is further configured to receive a plurality of SRS resource sets, wherein SRS resource sets of the plurality of SRS resource sets are associated with different sets of reference signals for determining SRS spatial precoders.

17. The apparatus of claim 1, wherein, to receive the at least one SRS resource set, the at least one processor is configured to receive a single SRS resource set, and wherein the at least one processor is further configured to receive a set of distinguished cyclic transmission occasions for the SRS resource set.

18. The apparatus of claim 17, wherein a channel state information reference signal (CSI-RS) is set for each transmission occasion of the set of distinguished cyclic transmission occasions.

19-29. (canceled)

30. A method for wireless communications, comprising:
receiving an indication of at least one sounding reference signal (SRS) resource set from a network entity;
transmitting, during a first SRS transmission occasion, a first set of SRS signals based on a first set of SRS resources from the at least one SRS resource set;
transmitting, during a second SRS transmission occasion, a second set of SRS signals based on a second set of SRS resources from the at least one SRS resource set, wherein the second set of SRS signals are transmitted after the first set of SRS signals, wherein the first set of SRS signals and second set of SRS signals are time division multiplexed (TDM) SRS signals;
receiving, from the network entity after the second set of SRS signals are transmitted, a first SRS resource indicator (SRI), the SRI identifying a first SRS signal from the first set of SRS signals; and
transmitting an uplink message to the network entity based on the first SRS signal.

31-32. (canceled)

33. An apparatus for wireless communications by a network entity, comprising:
at least one memory; and
at least one processor coupled to the at least one memory and configured to:
transmit an indication of at least one sounding reference signal (SRS) resource set to a user equipment (UE);
receive, during a first SRS transmission occasion, a first set of SRS signals based on a first set of SRS resources from the at least one SRS resource set;
receive, during a second SRS transmission occasion, a second set of SRS signals based on a second set of SRS resources from the at least one SRS resource set, wherein the second set of SRS signals are transmitted after the first set of SRS signals, wherein the first set of SRS signals and second set of SRS signals are time division multiplexed (TDM) SRS signals;
determine, a first SRS resource indicator (SRI), the SRI identifying a first SRS signal from the first set of SRS signals;
transmit, to the UE after the second set of SRS signals are received, the first SRS SRI; and
receive an uplink message from the UE based on the first SRS signal.

34-35. (canceled)
